(19) United States
(12) Patent Application Publication
(10) Pub. No.: US 2008/0315591 A1
(43) Pub. Date: Dec. 25, 2008

(54) Device and System for Producing Regenerative and Renewable Hydraulic Energy

(76) Inventor: Georg Hamann, Schleching (DE)

Correspondence Address: MOORE & VAN ALLEN PLLC, P.O. BOX 13706, Research Triangle Park, NC, 27709, US

(21) Appl. No.: 12/159,436

(22) PCT Filed: Dec. 28, 2006
(86) PCT No.: PCT/EP06/12584

§ 371 Date: Jun. 27, 2008

(30) Foreign Application Priority Data
Dec. 29, 2005 (DE) 10 2005 062 908.3

(51) Int. Cl. F03B 13/00

(52) U.S. Cl. 290/54

(57) ABSTRACT

The invention relates to a device for producing regenerative and renewable hydraulic energy, comprising at least one generator for producing electric energy, and a drive shaft which is connected to the generator and which comprises a plurality of blades which extend at least partially into the passing water and are set rotating by the water. Said blades are offset in relation to each other and along the drive shaft. The invention also relates to a system which consists of a plurality of said inventive devices.

The present invention relates to a water-powered device for producing regenerative and renewable energy as set forth in the preamble of claim 1.

The present invention relates furthermore to a water-powered system for producing regenerative and renewable energy, comprising a plurality of such devices.

For more than a 100 years water has been used to generate energy. Existing water power stations are designed each in accordance with water flow and the declivity involved as a function of which Pelton, Francis and Kaplan turbines or water wheels find application. Known furthermore are ducted turbines as well as so-called hydraulic or Archimedes screw.

Since years or even decades there has been no cause to further develop these known versions of such water wheels and turbines.

Employing these various types of turbine as indicated above is dictated, on the one hand, by the water flow involved and, on the other, by the declivity or pounding pressure. Thus, Pelton turbines, for example, find application where the declivity and pressure is high but the water flow involved is low, whereas Kaplan turbines are put to use where the declivity is small and only a medium water flow is involved. However, when both declivity and water flow involved are small, these known types of turbine cannot be employed.

In addition to this, when the water flow involved differs or changes this likewise presents problems for these known types of turbines which are designed for a relatively restricted range as to the water flow involved. If the water flow involved is too high or too low, the turbine cannot function.

The ceiling on the efficiency of these types of turbine, some of which have existed for a very long time, has been reached, leaving no room for a further increase, thus failing to prompt corresponding further developments.

It is not ultimately because of the spiraling increase in the cost of fossil fuels and their limited availability that recent years have seen a dramatic need materializing for generating energy from renewable sources, the use of which has the advantage of not adding to what is called the greenhouse effect.

The disadvantage of known water power station systems is the enormous changes they cause to the nature of the surroundings involving extreme construction complications as evident from the new, recently completed hydroelectric power plant in China.

This is why the present invention is based on the object of providing a water-powered device for producing regenerative and renewable energy which excels by being particularly compatible with the environment and which is simple in structure and simple to install whilst being exceptionally efficient in the face of differing water availability conditions.

Furthermore, the invention is to provide a system with such devices for a corresponding modular configuration.

The water-powered device for producing regenerative and renewable energy comprises at least one generator for producing electrical energy, and a drive shaft which is connected to the generator and which comprises a plurality of blades which are set rotating by the passing water flow. By the blades being arranged interstaggered along the drive shaft, the pressure exerted by the passing water is optimally exploited, resulting in a surprisingly high rotary speed of the drive shaft and a high torque.

It is particularly the rotary speed and torque of the device in accordance with the invention that are more constant than in conventional turbine types and systems.

The water-powered device in accordance with the invention for producing regenerative and renewable energy achieves a wealth of advantages, including:
simple and easy to install without involving construction activities;
regional basic supply possible by being sited near to the power consumer;
universal and, where necessary, automatic adaptation of the device to existing flow conditions in thus assuring optimized response of the device in accordance with the invention;
environmentally friendly energy production;
device can be sized optimized to the energy supply required, for example case-sized set for siting in remote communities and the like:
device can be adapted to any flow of water and diverse flow conditions;
zero emission energy production;

To advantage the blades are configured repeller-type, i.e. having a configuration similar to that of propellers which by definition serve to propel (for example an aircraft or ship) whereas repellers are powered by the surrounding flow of the medium. The term “repeller-type” is understood to be repellers which may comprise one, two or also more blades.

Advantageously in accordance with the invention the pitch of the blades is interadjustable to optimize exploitation of the passing air flow, the pitch of the blades along the drive shaft may differ one from the other.

It is furthermore of advantage that the spacing of the blades is adjustable in the longitudinal direction of the drive shaft as may differ or not be constant.

It is also furthermore of advantage that the pitch of the blade face is adjustable relative to the drive shaft, resulting in the blade face being positionable in accordance with the pressure of incident air flow and as may differ over the length of the drive shaft. Positioning may be done computer-controlled and/or by mechanical, electromechanical, pneumatic or hydraulic means.

What is especially of an advantage with the device in accordance with the invention is that it can be optimally adapted to the existing “water power diagram”, pitching the blading being done to advantage computer-controlled. The water power diagram may reflect the following parameters; (water flow (in m3/sec), declivity, flow energy and dynamic poundage pressure response.

The water power diagram is captured over the length of the drive shaft where necessary by means of suitable sensors and the pitch of the blading adapted to the changes in the water power diagram in thus optimizing efficiency of the device in accordance with the invention,

Due to the blades being releasably fitted to the drive shaft blades having become worn out or damaged can be speedily replaced new.

In a first preferred embodiment the drive shaft is directly connected to the generator in powering it directly. As an alternative the drive shaft can be connected to the generator also via a suitable gearbox.

Due to the drive shaft being mounted in a frame, for example, rectangular in shape, all the advantages of a simple, compact, structure designed for facilitated shipment and installation are achieved. It is also to advantage that the generator can also be mounted on the frame.

It is furthermore of advantage that the frame is arranged in a semi- or fully closed trough through which the water is directed controlled.

Since the device lends itself to being arranged horizontally, inclined or even vertically it has the advantage of being universally employable. It can be put to use either in a normal flow of water as in a river or stream, on a slope or even in a vertical water fall.

To advantage the device in accordance with the invention can be arranged preferably in the middle between two floats and preferably tethered. The huge benefit of this is that the device floats on the water making it possible to locate the device in accordance with the invention on flowing water to generate electrical energy from the flow. On top of this, it has the major advantage that use of the device is not indicated by the water level, because it follows the level, thus enabling it to be used even in high water. By suitable tethering it is also possible to adapt the device to changes in the direction of flow of the water without necessitating additional means.

This is further supported by the device comprising to advantage a self-orienting rudder assembly.

It is furthermore of advantage that the device comprises guide or jet pipes which direct the flow of water to the outer ends of the blades, optimizing flow impact of the blades.

It is furthermore to advantage that the drive shaft mounting the blades is mounted height-adjustable so that the immersion depth of the blades in the passing flow of water is adjustable as may be changed to advantage along the drive shaft. Height-adjustment may be achieved to advantage by pivoting the drive shaft, for example, by means of pivot arms mounted single-endedly.

As commented above, the device for producing energy in accordance with the invention results in substantially rotational velocities which may cause vibrations. To advantage, therefore, the drive shaft runs in bearings at both ends as well as at least one further location, for example at two to five locations, between the ends, resulting, on the one hand, in the completely device gaining in rigidity and, on the other, in rotation of the drive shaft being substantially less or even free of vibrations.

To advantage oil-less, sealed-for-life plain or ball bearings also made of plastics or ceramics are provided as the drive shaft bearings, because they, on the one hand, feature a long life, and, on the other, pose no risk of becoming soiled by the passing flow of water.

It is furthermore to advantage that the drive shaft is engineered as a splined shaft and the mount of each blade as a splined mount. This achieves a system for fitting the blades to the drive shaft which is simple, effective and easy to adjust whist ensuring their stable running at the drive shaft for smooth power transfer to the drive shaft.

Flowing water carries not only debris such as driftwood or leaves but may also involves fish, this being the reason why the device is fronted by a preferably pointed plough-type debris screen to prevent debris entering the device in accordance with the invention, the protection of which can be further enhanced by a mesh cage surrounding the device.

A particularly advantageous configuration of the blades materializes in that two each blades offset by 180° form a common tubular comprising a cavity in which a fluid is accommodated. In this arrangement the fluid does not fill the cavity completely, preferably substantially half of the cavity which is configured symmetrical in the two halves of the blade. When the cavity is located horizontal essentially the same amount of fluid is in both halves of the cavity. On further rotation of the blades the fluid is suddenly accelerated by the force of gravity causing the blades to rotate further. With a plurality of tubular blades a constant rotary speed and a substantially constant torque materializes. Although the fluid is water to advantage, any other suitable fluid can be employed.

This configuration is particularly suitable when the water flow is weak because only a low amount of driving energy is needed from without to cause the blades to rotate.

Another object of the present invention is a water-powered system for producing regenerative and renewable energy, characterized in that it comprises a plurality of devices as set forth in any of the claims 1 to 24 arranged one behind the other and/or alongside each other and/or above each other.

One such system can thus be engineered modulized to be universally adaptable to the application conditions, such as, for example, width of river, active length, water depth, etc.

In one special embodiment the drive shafts of the devices are also interconnected universally to thus drive a generator in common.

Further details, features and advantages read from the following description with reference to the attached drawings in which

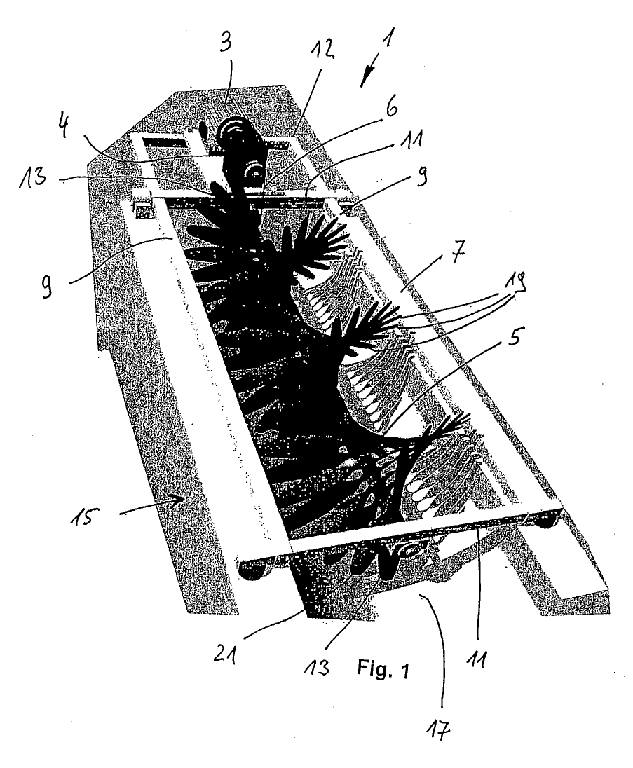

FIG. 1 is a front view in perspective, top left of a first embodiment of the device in accordance with the invention for producing regenerative and renewable energy;

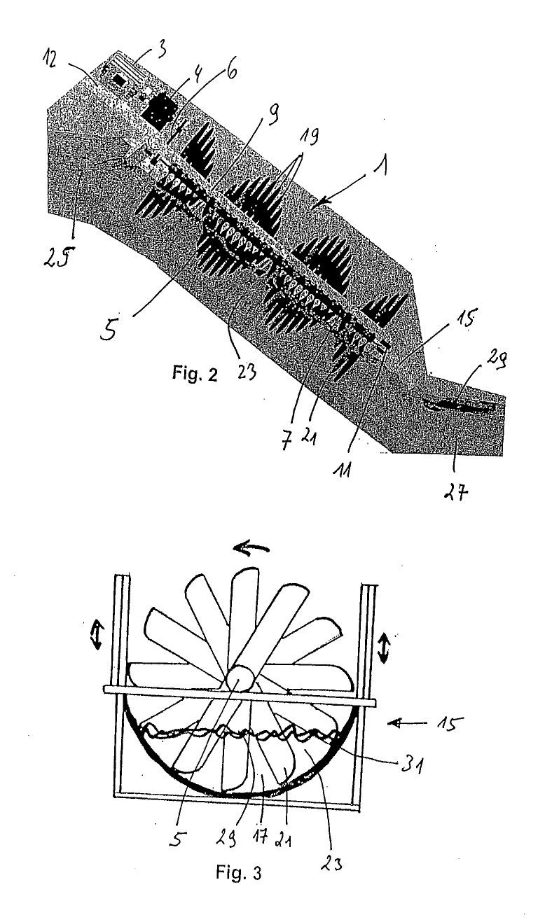

FIG. 2 is a side view of the first embodiment of the device in accordance with the invention as shown in FIG. 1;

FIG. 3 is a front view of a second embodiment of the device in accordance with the invention;

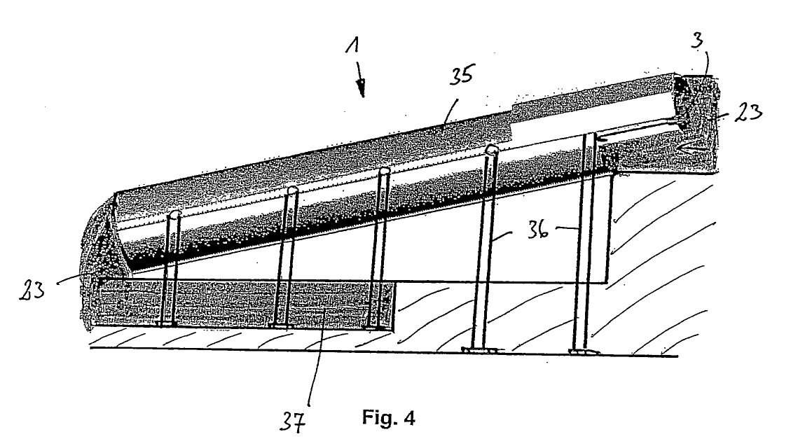

FIG. 4 is a diagrammatic side view of a ducted device in accordance with the invention;

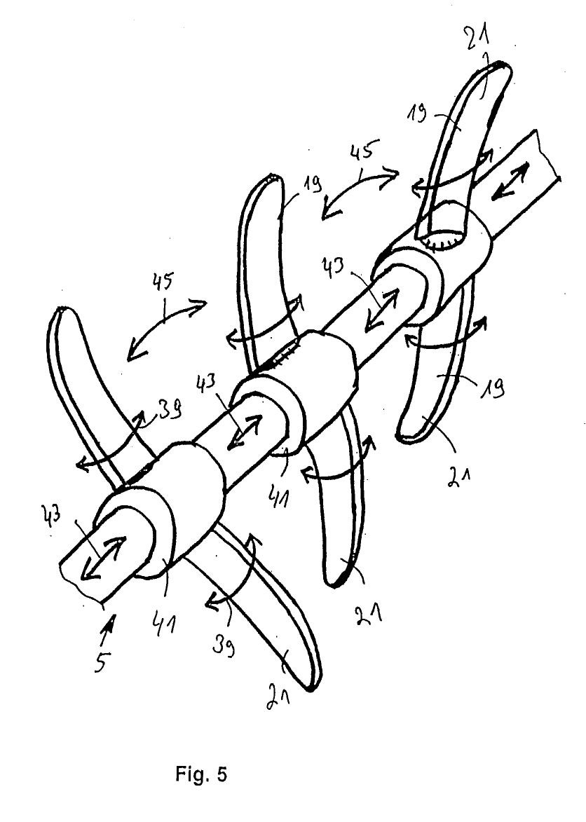

FIG. 5 is a diagrammatic partial view of the drive shaft with blades of the device in accordance with the invention;

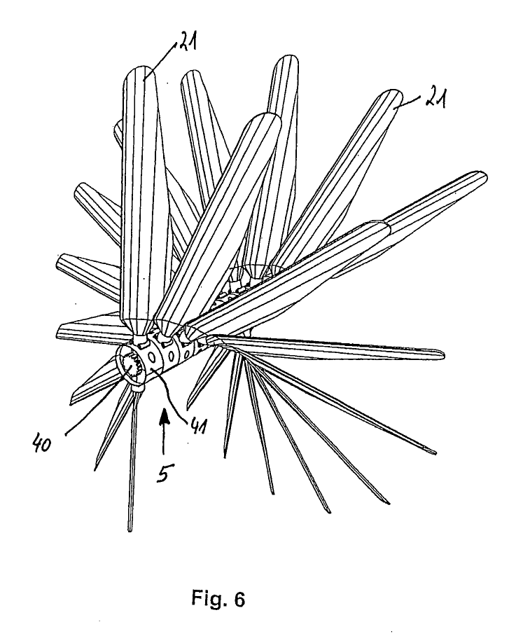

FIG. 6 is a partial view in perspective of one design aspect of the drive shaft showing the blades and their bearings;

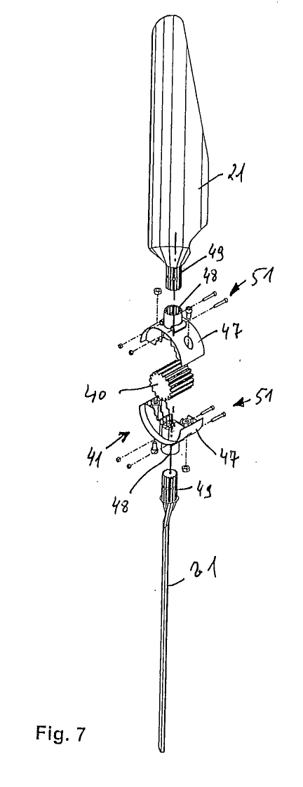

FIG. 7 is an exploded view of a bearing portion with two blades on the drive shaft;

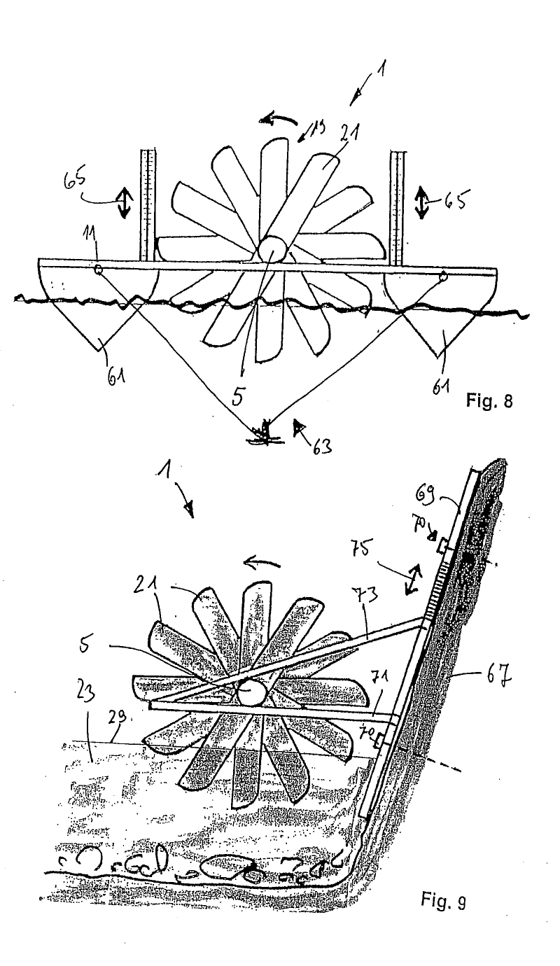

FIG. 8 is a front view showing the principle arrangement of a floating embodiment of the device in accordance with the invention;

FIG. 9 is a view showing how an embodiment of the device in accordance with the invention is tethered to an embankment;

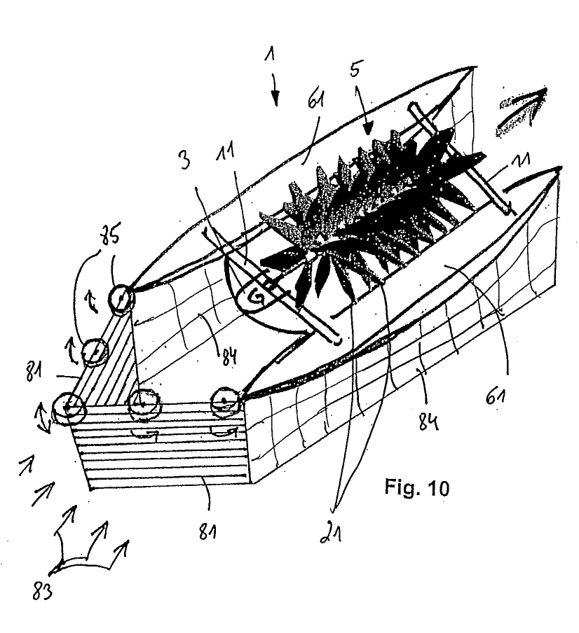

FIG. 10 is a view of a floating embodiment of the device in accordance with the invention incorporating pointed plough-type debris screens;

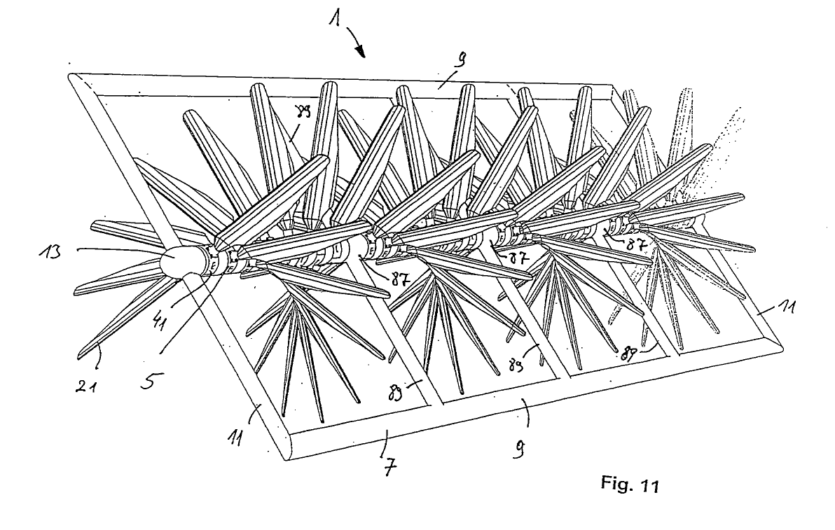

FIG. 11 is a view of a further embodiment of the device in accordance with the invention showing the drive shaft running in multiple bearings;

FIG. 12 is a front view of a further embodiment of the device in accordance with the invention;

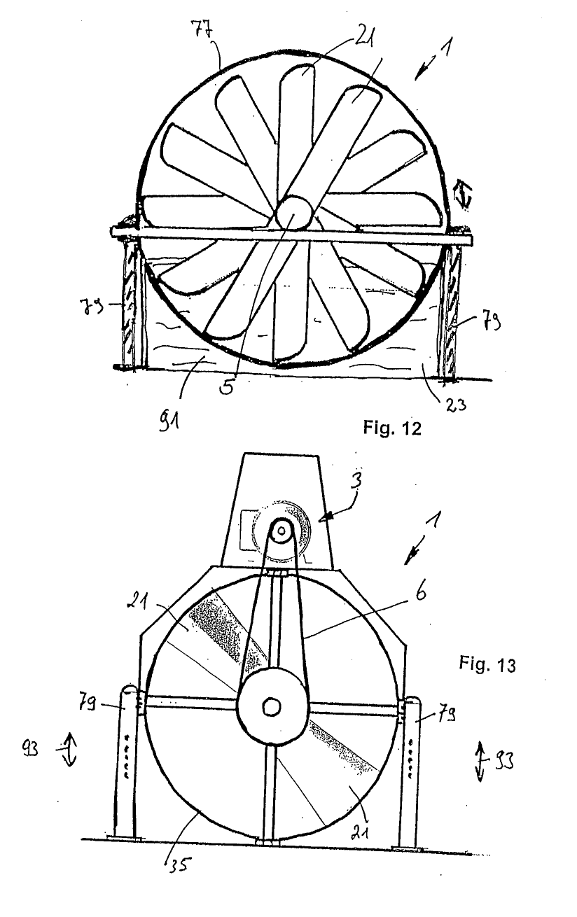

FIG. 13 is a front view of an embodiment of the device in accordance with the invention featuring a belt drive;

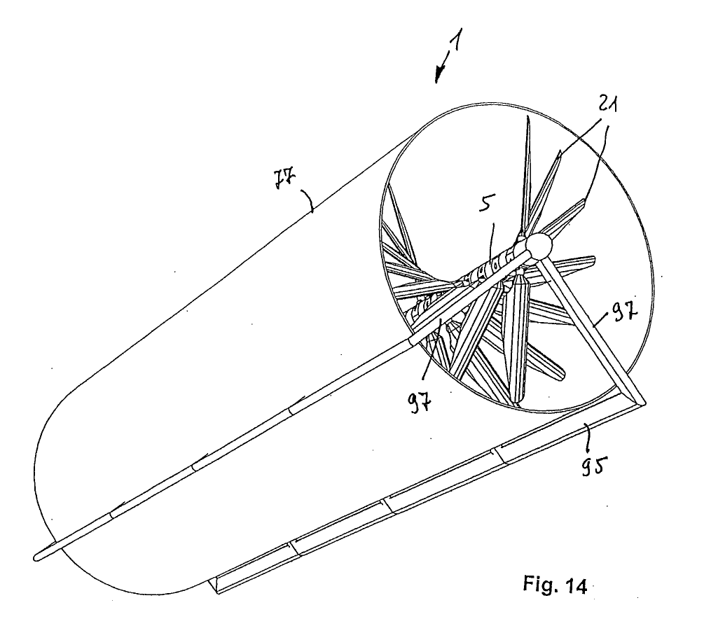

FIG. 14 is a view in perspective of a ducted embodiment of the device in accordance with the invention;

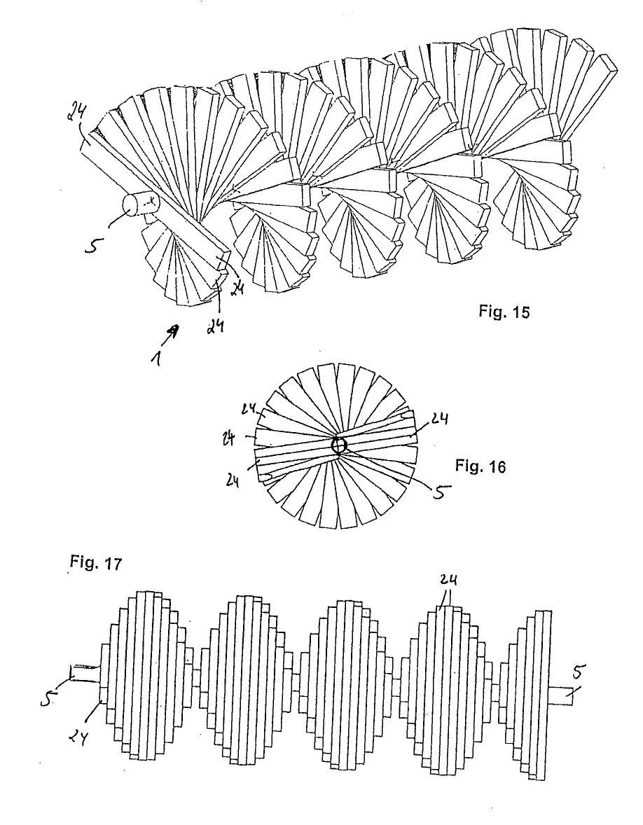

FIG. 15 is a view in perspective of a further embodiment of the drive shaft of the device in accordance with the invention with tubular blades;

FIG. 16 is a front view of the embodiment as shown in FIG. 15;

FIG. 17 is a side view of the embodiment as shown in FIG. 15;

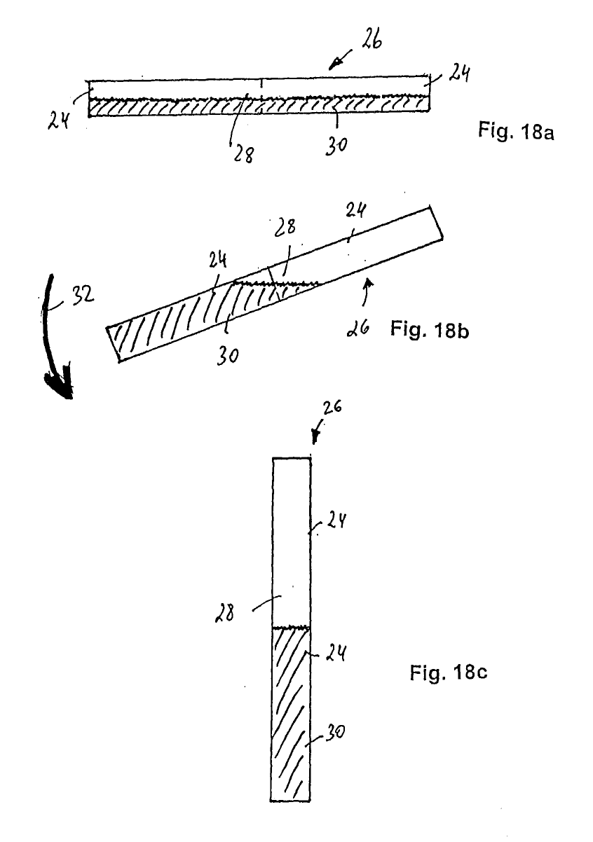

FIGS. 18a to 18c are each a magnified diagrammatic view of the embodiment with tubular blades; and

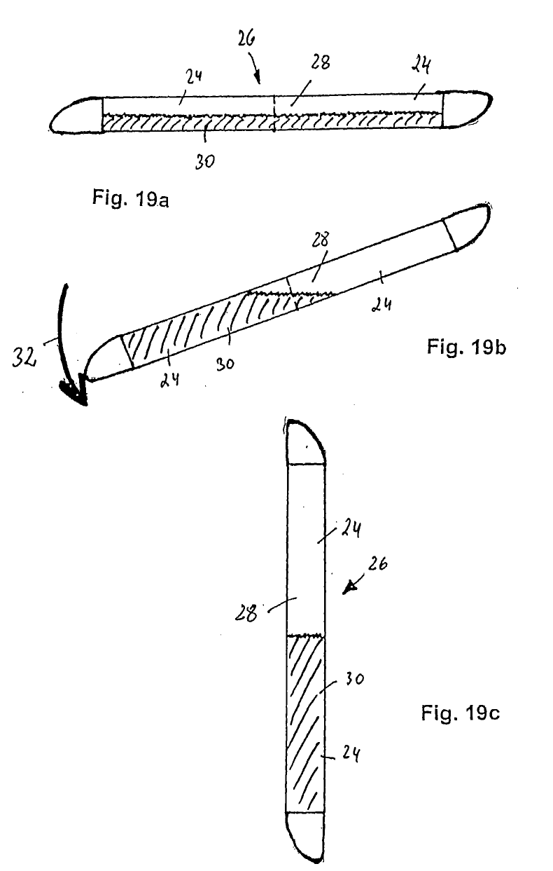

FIGS. 19a to 19c are each a view of a variant of the blades as shown in FIGS. 18a to 18c.

Like components as shown in the FIG. are identified in the following description by like reference numerals.

Referring now to FIG. 1 there is illustrated a first embodiment of a water-powered device in accordance with the invention for producing regenerative and renewable energy showing its basic arrangement. As shown in FIG. 1 the device 1 in accordance with the invention comprises a generator 3 which in the example aspect is connected via a gearbox 4 and belt 6 to a drive shaft 5.

The drive shaft 5 is arranged in the middle of a frame 7 configured rectangular and featuring two side members 9 and two cross members 11. In addition, the frame 7 comprises an added portion 12 mounting the gearbox 4 and the generator 3.

At each end the drive shaft 5 runs in bearings 13 mounted on the assigned cross member 11.

The frame 7, as shown in FIG. 1, is located on an elongated trough 15 and the drive shaft 6 is sited in the region of the upper side of the flow channel 17 configured in the trough 15.

As evident from FIG. 1 furthermore arranged along the drive shaft 5 is a plurality of repellers 19 same shaped as propellers. Each repeller 19 comprises two blades 21 offset by 180° which are set rotating by the flow of water (see FIG. 2). As already mentioned, the repellers 19 may also comprise just one blade or more than two blades 21.

The blades 21 and the repellers 19 respectively are arranged along the drive shaft 5 offset. In other words, the blades 21 of one repeller 19 are pitched relative to the blades 21 of the next repeller 19 by an adjustable angle to achieve an optimum transfer of force of the medium streaming by.

Referring now to FIG. 2 there is illustrated diagrammatically how the device 1 in accordance with the invention features inclined the trough 15 for a flow of water 23 from an inflow 25 at the top down through the trough to an outlet 27. It is this flow of water that causes the blades 21 to rotate in thus the complete drive shaft 5 which via the belts 6 and gearbox 4 drives the generator 3.

Referring now to FIG. 3 there is illustrated the device 1 in accordance with the invention in a diagrammatic front view showing how the upper water level 29 of the water 23 is located below the drive shaft 5 so that only some of the blades 21 are immersed in the water 23.

The flow channel 17 is formed by a circular duct open upwards.

Illustrated furthermore diagrammatically in FIG. 3 is how the level of the drive shaft 5 can be swept up or down, the level as shown in FIG. 3 being the bottommost level.

Referring now to FIG. 4 there is illustrated a diagrammatic side view of a ducted device 1 in accordance with the invention arranged inclined and showing how the water 23 flows through a duct 35 configured circular and preferably made of sheet aluminum. Accommodated within the duct 35 is the drive shaft with the blades (not shown).

As evident from FIG. 4 the inflow of water 23 totally fills the inlet cross-section of the duct. In this embodiment the generator 3 can be enveloped in the flow of water. As an alternative the drive shaft can be arranged in a universal connection with a generator (not shown) sited externally.

The duct is mounted on supports 36 arranged substantially equally interspaced. Provided below the outlet of the duct 35 is an outlet tank 37.

As shown in the example aspect illustrated in FIG. 4 the inflow cross-section of the duct is totally filled with the flow of water. But the device in accordance with the invention will also generate electrical energy even when the inflow cross-section is not fully filled with the flow of water, the total flow filament of the cross-section of the duct materializing later or even not at all.

Referring now to FIG. 5 there is illustrated diagrammatically the optimum means of pitching the blades 21 of the repellers 19 on the drive shaft 5.

To advantage each blade 21 runs in a bearing element 41 for rotation as indicated by the double arrow 39 so that each blade face 22 can be correspondingly pitched individually relative to the passing flow of water.

Furthermore the repellers 19 can be set spaced away from each other along the drive shaft as indicated by the double-arrows 43. The possibilities as shown in FIG. 5 are merely examples and the arrangement of the individual repellers 19 does not correspond to their real setting, the double-arrows 45 indicating their rotatability as shown in FIGS. 1 and 2, for example.

This possibility for an optimum setting as achieved in accordance with the invention results in the flow-mechanical response along the drive shaft being utilized optimally with the additional possibility of using not just identical blades 21 as shown in FIG. 5 but also differing blades having differing blade faces permitting optimization of the device in accordance with the invention.

Referring now to FIG. 6 there is illustrated a diagrammatic view in perspective of a design embodiment of the drive shaft 5 featuring a splined shaft 40 comprising a longitudinal arrangement of splines as is better evident from FIG. 7 showing the configuration in an exploded view. The bearing element 41 is devised split with two bearing shells 47 each of which comprises a splined inner contour mating with the splines of the splined shaft 40 to positively clasp the splined shaft 40.

Inserted in each bearing shell 47 is a mounting bush 48. In this arrangement the axes of the bushes 48 are inline so that the blades 21 are arranged precisely offset by 180 deg. Internally the mounting bushes 48 feature a splined profile positively mating with a splined profile of a gearbox 49 of each blade 21. This positive splined connection enables the blades 21 to be positioned turned as wanted whilst making it very simple to stagger a pair of blades 21 relative to the adjoining pair(s) by staggering the bearing shell 47 about the splined shaft 40. Conventional fasteners 51 involving nuts and bolts serve to secure the bearing shells 47 to each other and respectively the mounting bushes 48 to the bearing shells.

Referring now to FIG. 8 there is illustrated a front view of a further embodiment of the water-powered device in accordance with the invention for producing regenerative and renewable energy.

Unlike the embodiment as shown in FIGS. 1 and 2 the device 1 in accordance with the invention is not sited on a trough but on pontoons or floats 61 floating on the surface of the water. The floats 61 feature to advantage a tether 63 configured for example in the form of tethered cable ropes giving the float 61 the freedom to orient itself in the direction of the passing flow of water.

As evident from FIG. 8 it is possible to advantage to set the level of the drive shaft 5 together with its blades 21 as indicated by the arrows 65.

Referring now to FIG. 9 there is illustrated a further advantageous embodiment of the present device 1 in accordance with the invention as may be tethered for example to the corresponding retaining rails 69 on an embankment 67 by means of corresponding retaining struts 71 and 73. The retaining rails 69 are secured to the embankment 67 by suitable fasteners 70.

As evident from FIG. 9 furthermore the blades 21 are immersed in the water 23 only to a certain degree. When the water level 29 changes the device 1 in accordance with the invention can be raised and lowered accordingly as indicated by the double arrow 75 to achieve an optimum response of the device in accordance with the invention.

As an alternative the device in accordance with the invention may also be mounted for pivoting on corresponding pivot arms (not shown) which in turn are pivot-mounted at the embankment. This makes it possible by extremely simple ways and means to set both the immersion depth of the blades 21 in the water 23 as well as conversely, with the immersion depth set constant as wanted, to adapt the device as a whole to the water level 29 as existing and changing, as may be.

Referring now to FIG. 10 there is illustrated an embodiment similar to that as shown in FIG. 8, but now featuring the floats 61 fronted by a debris screen 81, preferably having the shape of a pointed plough. The debris arriving in the direction of flow (arrows 83) is side-tracked by the debris screen so as not to gain access to the space between the two floats 61. For further protection, but especially also from fish, nets 84 may be provided below the float 61 and, where necessary, also aft (not shown).

To divert the drifting debris, round deflectors 85 are furthermore provided floating at the top or near to the surface of the water which can preferably turn in the direction of flow to bypass incoming debris on the water surface from the device 1 in accordance with the invention.

Referring now to FIG. 11 there is illustrated a further embodiment of the device 1 in accordance with the invention featuring similar to that as shown in FIG. 1 a frame 7, it being evident how the spacing between the individually pairs of blades 21 is provided correspondingly. Although this is indicated substantially constant, it is just as possible that differing spacings may be provided.

Additional bearings are provided furthermore for the drive shaft 5 to run with minimum vibration, corresponding bearings 87 being connected to the frame 7 and side members 9 by cross-struts 89.

Referring now to FIG. 12 there is illustrated another embodiment of the device 1 in accordance with the invention housed in a duct 77 similar to that as shown in FIG. 4, supports 79 serving to mount the complete device. The duct 77 may be arranged horizontally, water 23 flowing beneath and sideways of the duct 77 in forming a passageway for fish.

When the duct 77 is arranged inclined the space 91 beneath the duct 77 can be configured as a fish ladder.

Referring now to FIG. 13 there is illustrated a further aspect of the device 1 in accordance with the invention similar to that as shown in FIG. 4 but now with the generator 3 arranged above the duct 35 and as indicated by the arrows 93 the supports 79 are engineered height-adjustable.

The belts used may be flat, vee or also ribbed belts.

Referring now to FIG. 14 there is illustrated a view in perspective of a ducted embodiment of the device in accordance with the invention similar to that as shown in FIG. 12, showing, however, how a bearing frame 95 mounts both the drive shaft 5 and the duct 77 and how both legs 97 of the bearing can cover an angle of substantially 90 deg.

Referring now to FIGS. 15 to 17 there is illustrated an alternative embodiment of the device in accordance with the invention, FIG. 15 being a view in perspective, FIG. 16 a front view and FIG. 17 a side view. Referring now to FIGS. 18a to 18c there are illustrated two blades 24 of a repeller on a magnified scale, offset to each other by 180°, forming together a tubular profile 26 in which an elongated cavity 28 is configured. This elongated cavity 28 is sealed off from the ambience and comprises a fluid 30, preferably water which does not completely fill the cavity 28, but substantially only by half. When the blades 24 of a pair forming the tubular profile 26 turn from the horizontal position as shown in FIG. 18a in which the fluid 30 is accommodated substantially equally distributed in the cavity 28, to one side as indicated by the arrow 32 the fluid 30 is abruptly moved by the force of gravity into the partial cavity (see FIG. 18b) being lowered, resulting in the corresponding blades 24 being suddenly torqued. FIG. 18c shows the filled cavity 28 in its lowest position turning further again into the position as shown in FIG. 18a, and so forth.

Referring now to FIGS. 19a to 19c there is illustrated a variant of the embodiment as shown in FIGS. 15 to 18c. Provided at the sides and ends of the blades 24 are vane-type tips 34 making for an even better blade face especially in weak flowing water.

As readily evident from the spiral arrangement as shown in FIG. 15 this abrupt motion is propagated to rotate the drive shaft 5. It will be appreciated that the dynamic response native to this device results in only little external energy being needed to rotate the drive shaft 5, this variant thus being particularly suitable for application in weak flowing water.

The water-powered device in accordance with the invention for producing regenerative and renewable energy achieves a wealth of advantages, including:
simple and easy to install in flowing water without involving construction activities, thus making it available with minimum delay;
regional basic supply possible by being sited near to power consumers;
full system configured modular by a plurality of single devices to optimally exploit passing water as a function of the conditions in situ;
universal and, where necessary, automatic adaptation of the device to existing flow conditions in thus assuring optimized response of the device in accordance with the invention;
environment friendly energy production;
device can be sized optimized to the energy supply required, for example case-sized set for siting in remote alpine regions and the like;
device can be adapted to any flow of water and diverse flow conditions;
zero emission energy production;
depending on the embodiment it can be encapsulated for particularly low-noise operation.

Hitherto this description relates to a device in accordance with the invention suitable as a stationary installation for generating energy. However, it may also be put to use to power floating vessels by energy being produced stationary for storage in corresponding accumulators. When the vessel needs to be propelled, the stored energy serves to power corresponding devices to propel the vessel. To recharge the accumulators the vessel is then returned to face the flow of water.

As an alternative the power generator and propelling system of the vessel can be operated simultaneously so that the generated energy finds direct use in propelling the vessel.

1-24. (canceled)

25. A water-powered device for producing regenerative and renewable energy, the device comprising
a plurality of blades extendable at least partially into passing water, which are set rotating by the passing water, the blades being arranged interstaggered along a drive shaft and configured repeller-type; and
at least one generator for producing electrical energy connected to the drive shaft, wherein the pitch of the blades is interadjustable.

26. The device of claim 25, wherein the blades are adjustable in the longitudinal direction of the drive shaft.

27. The device of claim 25, wherein the pitch of the blade face is adjustable relative to the drive shaft.

28. The device of claim 25, wherein adjusting the blades is computer-controlled, the adjustment being by mechanical, electromechanical, pneumatic or hydraulic means.

29. The device of claim 25, wherein the blades are releasably fitted to the drive shaft.

30. The device of claim 25, wherein the drive shaft is directly connected to the at least one generator.

31. The device of claim 25, wherein the drive shaft is mounted in a frame.

32. The device of claim 31, wherein the frame is arranged in a semi-open or closed trough or the frame is arranged in a duct.

33. The device of claim 25, wherein the device is arranged horizontal, inclined or vertical.

34. The device of claim 25, wherein the device is arranged in the middle between two flotation objects or floats and the device further comprises a tether.

35. The device of claim 34, wherein the device further comprises a self-orienting rudder assembly.

36. The device of claim 25, wherein the device further includes directing or jetting pipes which direct the water flow to the outer ends of the blades.

37. The device of claim 25, wherein the drive shaft mounting the blades is mounted height-adjustable.

38. The device of claim 37, wherein the drive shaft is pivotally mounted.

39. The device of claim 25, wherein the drive shaft runs in bearings at both ends and at least one further location between the ends.

40. The device of claim 39, wherein the drive shaft bearings are sealed-for-life, oil-less plain or ball bearings made of plastic or ceramic.

41. The device of claim 25, wherein the drive shaft is engineered as a splined shaft and the mount of each blade is a splined mount.

42. The device of claim 25, wherein the device further comprises a fronted debris screen of the pointed plough-type, the screen having round deflectors located top floating or in the region of the water surface and therebelow.

43. The device of claim 25, further comprising a mesh cage surrounding the device.

44. The device of claim 25, wherein two each blades offset by 180° form a common tubular profile comprising a cavity in which a fluid is accommodated.

45. The device of claim 44, wherein the fluid in the cavity is water.

46. The device of claim 44, wherein the fluid fills substantially half of the cavity.

47. A water-powered system for producing regenerative and renewable energy, the system comprising
a plurality of devices, each device comprising
a plurality of blades extendable at least partially into passing water, which are set rotating by the passing water, the blades being arranged interstaggered along a drive shaft and configured repeller-type; and
at least one generator for producing electrical energy connected to the drive shaft,
wherein the pitch of the blades is interadjustable,
wherein the plurality of devices are arranged one behind the other and/or alongside each other and/or above each other.

48. The system of claim 47, wherein the drive shafts of the devices are interconnected universally.
